(19) United States
(12) Patent Application Publication
(10) Pub. No.: US 2026/0110856 A1
(43) Pub. Date: Apr. 23, 2026

(54) FERRULE-TYPE OPTICAL FIBER CONNECTOR

(71) Applicant: NINGBO LITAS OPTICAL TECHNOLOGIES CO., LTD., Ningbo (CN)

(72) Inventors: Benjamin Bin JIAN, Ningbo (CN); Yanhe XIAO, Ningbo (CN); Zunzhu LIU, Ningbo (CN)

(21) Appl. No.: 19/158,051

(22) PCT Filed: Feb. 2, 2024
(86) PCT No.: PCT/CN2024/075474

§ 371 Date: Aug. 20, 2025

(30) Foreign Application Priority Data
Feb. 21, 2023 (CN) 202310181157.8

(51) Int. Cl. G02B 6/38

(52) U.S. Cl. CPC G02B 6/387; G02B 6/3882

(57) ABSTRACT

The invention discloses a ferrule-type optical fiber connector, which comprises a connector mainbody, an elastic tailseat matched with the connector mainbody, a first ferrule and a second ferrule coupled with each other; the second ferrule is set on the connector mainbody, the first ferrule is set on the elastic tailseat, the elastic tailseat comprises a spring, characterized in that the spring is set on the side of the first ferrule. An advantage is that by arranging the spring for elastically connecting the first ferrule and the second ferrule on the side of the first ferrule, the total length of the entire optical fiber connector is no longer the sum of the total length of the ferrule body and the entire length of the spring. On the premise of meeting the connection and usage requirements, the total length of the entire optical fiber connector is minimized.

### TECHNICAL FIELD

The invention relates to an optical fiber connector, especially relating to a ferrule-type optical fiber connector.

### BACKGROUND

Currently, the vast majority of multi-fiber connectors available on the market are MPO fiber optic connectors. An MPO fiber optic connector is a fully functional fiber optic connector, which is based on a precision component known as the MT ferrule, accompanied by auxiliary parts such as a spring, a push-pull decoupling structure, and a tensile-resistant structure assembled via crimping. MPO fiber optic connectors are particularly suitable for applications involving thick optical cables with tensile resistance requirements.

However, for some application scenarios inside fiber optic communication system cabinets, such as optical connections in on-board optics and similar applications, another type of multi-fiber connector based on MT ferrules is required, which is called a ferrule-type multi-fiber connector. This ferrule-type multi-fiber connector does not need to prevent fiber stretching, but it requires a shorter total length and a more miniaturized design after mating than that of MPO fiber optic connectors.

For example, the U.S. patent application with publication number US2004/0189321A1 discloses an MT ferrule-type multi-fiber connector. Two MT ferrules are respectively placed in their receiving positions, wherein one MT ferrule is equipped with guide pins. After the guide pins are inserted into the guide pin holes of the opposite MT ferrule for alignment, a spring presses the two MT ferrules into tight mating.

In addition, there is a ferrule-type multi-fiber connector shown in FIG. 1 (A) (B). FIG. 1(A) is an exploded view of the overall structure of this multi-fiber connector, which includes a connector mainbody A1, a male ferrule A2 and a female ferrule A3 that mate with each other, a spring A4, two elastic clips A5, a positioning guide pin A21, and a guide pin bracket A6.

The connector mainbody A1 is provided with a precision alignment tunnel that runs through from front to back. The male ferrule A2 and female ferrule A3 extend into the alignment tunnel from both ends of the connector mainbody A1 respectively, and are connected to the connector mainbody A1 via elastic clips A5. The tip of the positioning guide pin A21 on the male ferrule A2 extends into the matching positioning hole of the female ferrule A3, thereby achieving the mating of the male ferrule A2 and female ferrule A3. FIG. 1(B) is a cross-sectional view after mating.

To meet the requirements for contact force on the fiber end faces during coupling and the suspension requirement for ferrules during mating, the ferrule-type multi-fiber connector is equipped with a spring A4 “connected in series” at the rear end of the male ferrule A2, as shown in FIG. 1(A) and 1(B). This means that the total length of the entire connector in the front-rear direction must include the full length of the spring A4, making it impossible to meet the requirement for the shortest possible length. How to further reduce the total length of the optical fiber connector while satisfying the aforementioned contact force and ferrule suspension requirements has become an urgent problem to be solved.

### SUMMARY

The technical problem to be solved by the present invention is to provide a ferrule-type optical fiber connector with a simple structure and a short length.

The technical solution adopted by the present invention to solve the above-mentioned technical problems is as follows:
A ferrule-type optical fiber connector, comprising a connector mainbody, an elastic tailseat matched with the connector mainbody, a first ferrule, and a second ferrule coupled with each other; the second ferrule is set on the connector mainbody, the first ferrule is set on the elastic tailseat, the elastic tailseat comprises a spring, wherein the spring is set on the side of the first ferrule.
The elastic tailseat comprises a tailseat mainbody and an extending arm bracket; the first ferrule is supported on the extending arm bracket; the spring is set between the tailseat mainbody and the extending arm bracket.
There are two said springs; the extending arm bracket is provided with a ferrule contact surface for supporting the first ferrule and two flank contact surfaces for supporting and connecting with the spring. The ferrule contact surface is arranged behind the flank contact surface, and a spring is arranged between each flank contact surface and the tailseat mainbody.
The ferrule contact surface is provided with location guide pins; the first ferrule is installed on the extending arm bracket by inserting the location guide pin into the guide pin hole of the first ferrule.
The location guide pin extends out of the front surface of the first ferrule when the first ferrule is a male ferrule.
The spring is sleeved with a spring guide rod.
The tailseat mainbody is provided with a through groove, which is capable of delivering the optical fiber harness into the tailseat mainbody.
The elastic tailseat and the connector mainbody are detachably clamped.
The second ferrule is connected with the connector mainbody through the elastic tailseat.
The connector mainbody is provided with an anti-disengagement mechanism for stably mounting the second ferrule on the connector mainbody
The anti-disengagement mechanism comprises a swinging latch pivotally connected to the connector mainbody, the swinging latch comprises an anti-disengagement baffle; the anti-disengagement baffle can limit the second ferrule when the second ferrule is set on the connector mainbody.
An anti-disengagement locking mechanism is arranged between the swinging latch and the connector mainbody.

Compared with the prior art, the advantages of the present invention lie in the following: By arranging the spring for elastically connecting the first ferrule and the second ferrule on the side of the first ferrule, the total length of the entire optical fiber connector is no longer the sum of the total length of the ferrule body and the entire length of the spring. On the premise of meeting the connection and usage requirements, the total length of the entire optical fiber connector is minimized; by integrating the spring into the elastic tailseat, the number of components of the ferrule-type optical fiber connector is reduced to only two, which furthest optimizes the convenience of use.

### BRIEF DESCRIPTION OF THE DRAWINGS

FIG. 1(A) is an exploded view of the overall structure of the prior art.

FIG. 1(B) is a cross-sectional view of the prior art.

FIG. 2 is an exploded view of embodiment 1 of the present invention.

FIG. 3 is an exploded view of the elastic tailseat in the present invention.

FIG. 4 is a cross-sectional view of the assembled structure shown in FIG. 3.

FIG. 5(A) is an exploded view of the connector mainbody in the present invention.

FIG. 5(B) is a perspective view of the connector mainbody in the present invention.

FIG. 6 is a partial assembly view of embodiment 1 of the present invention.

FIG. 7 is a perspective view of the assembled Embodiment 1 of the present invention.

FIG. 8 is an exploded view of embodiment 2 of the present invention.

FIG. 9 is a perspective view of embodiment 2 of the present invention.

### DETAILED DESCRIPTION

The application will be described in detail below. Although specific embodiments of the present application are shown, it should be understood that the present application can be realized in various forms and should not be limited by the embodiments set forth herein. Rather, these embodiments are provided to be able to better understand the present application, and can completely convey the range of the application to those skilled in the art.

It should be noted that certain words are used in the specification and Claims to refer to a specific component. It should be understood by those skilled in the art, the technical personnel may use different noun to call the same component. This specification and claims do not distinguish components based on differences in nouns, but rather on differences in their functions. Throughout the specification and claims, the words “including” and “comprising” are open-ended terms and should be interpreted as meaning “including but not limited to”. The following description provides preferred embodiments of the present application. However, this description is intended for general purposes only and is not intended to limit the scope of the present application. The scope of protection of the present application shall be determined by the appended claims.

### Embodiment 1

As shown in FIG. 2, a ferrule-type optical fiber connector, apart from the two necessary ferrules, consists of only two pre-assembled components. It comprises a connector mainbody 1, an elastic tailseat 2 as well as first ferrule 3 and second ferrule 4 which are aligned and matched with each other. the elastic tailseat 2 is provided with two location guide pins 5.

### Elastic Tailseat

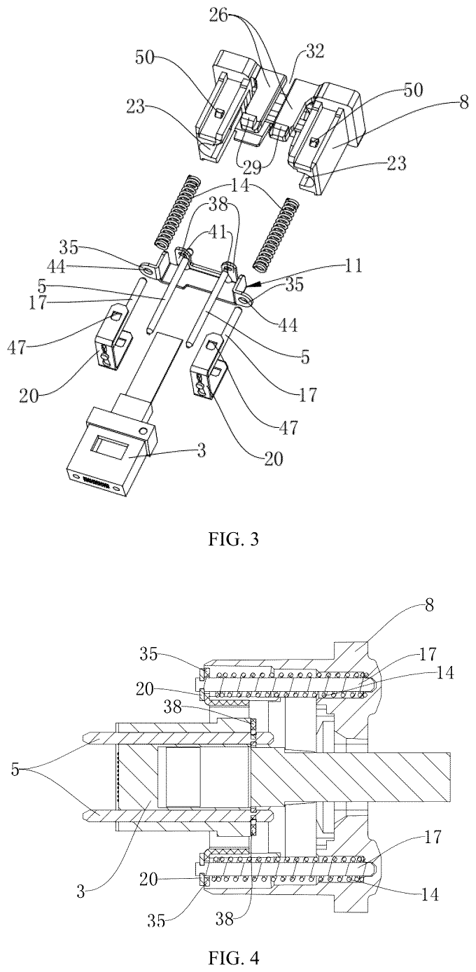

FIG. 3 is an exploded view of the elastic tailseat 2, which is composed of a tailseat mainbody 8, an extending arm bracket 11, two location guide pins 5, two springs 14, two spring guide rods 17, two baffle 20.

The tailseat mainbody 8 comprises two spring chambers 23 with closed ends and elastic arm 26. The ends of the elastic arm 26 is provided with connecting protrusion 29. Tailseat mainbody 8 is provided with through groove 32 which is capable of delivering the optical fiber harness into the tailseat mainbody 8.

The tailseat mainbody 8 is preferably made of plastic, though metal may also be used.

The extension arm bracket 11 is the key of the ferrule-type optical fiber connector. It is a bent guide pin bracket. With the contact surface of the ferrule as the front, the extension arm bracket 11 is provided with a ferrule contact surface 38, a guide pin retaining groove 41, and two flank contact surfaces 35 (facing backward). The ferrule contact surface 38 is arranged behind the flank contact surfaces 35.

The material of the extension arm bracket 11 needs to be sufficiently rigid and thick. The preferred material is stainless steel, with a preferred thickness of 0.30 mm or more.

When assembling the elastic tailseat 2, the two springs 14 and the flank contact surfaces 35 of the extension arm bracket 11 are placed into the spring chambers 23. The spring guide rods 17 passthrough the springs 14 and the through holes 44 of the extension arm bracket 11, and two ends of the spring guide rods 17 are fixed by the tailseat mainbody 8 and the baffle 20. The windows 47 on the baffle 20 are clamped and fixed with the connection protrusions 50 on the tailseat mainbody 8, and the spring chambers 23 form a closed structure.

The positioning guide pins 5 are fixed by the guide pin retaining grooves 41 of the extension arm bracket 11, and the positioning guide pins 5 are inserted into the guide pin holes of the first ferrule 3, thereby realizing the supporting connection of the first ferrule 3 on the extension arm bracket 11. The first ferrule 3, positioning guide pins 5, and extension arm bracket 11 move together as an assembly.

The spring guide rod 17 prevents the bending of the long spring 14 and reduces the friction between the spring 14 and the spring chambers 23. The spring guide rod 17 is optional and may be omitted.

FIG. 4 is a cross-sectional view of the elastic tailseat 2 after assembling.

The spring 14 and the flank contact surface 35 are placed into the spring chamber 23 of the tailseat mainbody 8 in sequence. The spring guide rod 17 passes through the through hole 44 of the flank contact surface 35 and the spring 14, with both ends of the spring guide rod 17 fixed by the tailseat mainbody 8 and the baffle 20, respectively. The assembly consisting of the first ferrule 3, positioning guide pin 5, and extension arm bracket 11 is guided by the two spring guide rods 17 and slides back and forth along the spring guide rods 17.

The spring 14 pushes the flank contact surface 35 of the extension arm bracket 11 to provide a forward elastic thrust to the first ferrule 3.

### Connector Mainbody

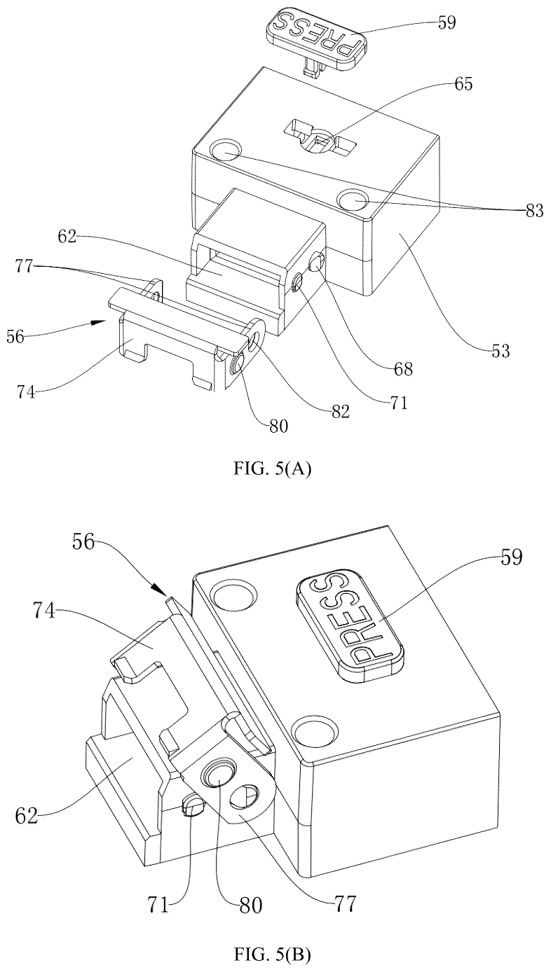

FIG. 5(A) is an exploded view of the connector mainbody 1, comprising a connector body 53, a swinging latch 56, and a release button 59.

The connector body 53 is provided with an alignment tunnel 62 penetrating front to rear, a window 65, a rotating shaft 68, and a convex point 71. There is a loose fit between the alignment tunnel 62 and the second ferrule 4, which not only provides sufficient ferrule alignment accuracy but also ensures the free entry and exit of the ferrule.

The swinging latch 56 includes an anti-disengagement baffle 74, two oppositely arranged swinging arms 77, two concave points 80, and two rotating holes 82. The two swinging arms 77 are respectively disposed on two opposite side surfaces of the connector body 53. The rotating holes 82 of the swinging latch 56 are pivotally connected to the rotating shaft 68 of the connector body 53.

The swinging latch 56 and the connector body 53 are locked through the two concave points 80 and the corresponding convex points 71. This is an anti-disengagement locking mechanism.

Two through holes 83 are opened on the connector body 53 to facilitate fixing to the machine base plate with screws.

The connector body 53 is provided with a window 65 for embedding the release button 59.

FIG. 5(B) is a perspective view of the assembled connector mainbody 1, where the swinging latch 56 is in an open state, waiting for the insertion of the second ferrule 4.

### Connector Coupling

The number of operating steps for mating a connector with this ferrule-type optical fiber connector is minimized, totaling only three essential steps. The butting process is as follows:

The first step is to insert the second ferrule 4 into the connector mainbody 1 and lock it with the swinging latch 56: the second ferrule 4 is inserted into the alignment tunnel 62 from the front end of the connector mainbody 1, and the swinging latch 56 rotates to the locked state. The anti-disengagement baffle 74 of the swinging latch 56 prevents the second ferrule 4 from disengaging from the connector mainbody 1, thereby achieving the stable installation of the second ferrule 4 on the connector mainbody 1.

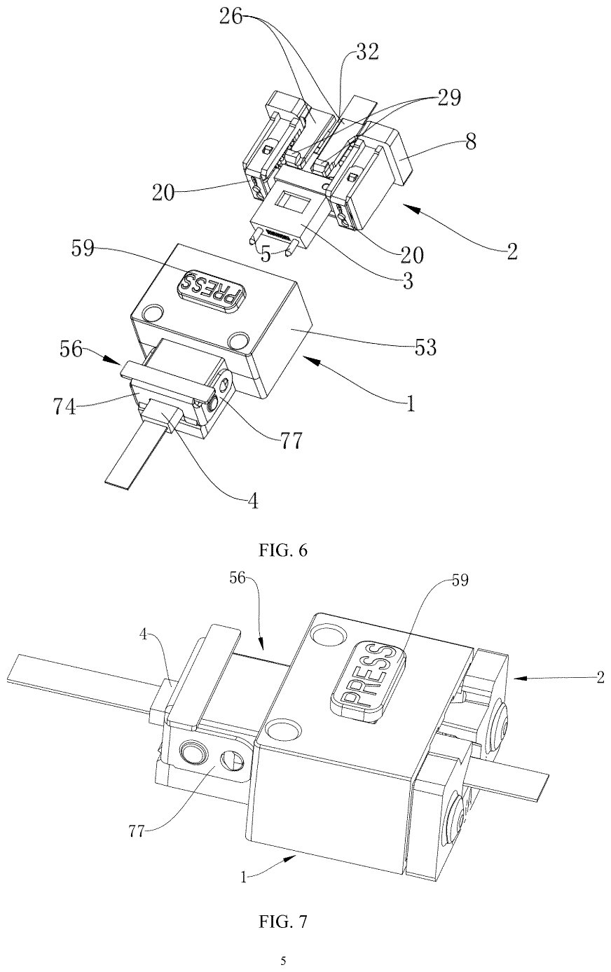

The second step is to insert the two positioning guide pins 5 on the elastic tailseat 2 into the two guide pin holes of the first ferrule 3. The state is as shown in FIG. 6 (partial assembly drawing).

The third step is to insert the elastic tailseat 2 with the first ferrule 3 into the connector mainbody 1. At this point, the first ferrule 3 is inserted into the alignment tunnel 62 from the rear end of the connector mainbody 1, completing the alignment and mating of the two ferrules.

When the elastic tailseat 2 is fittingly installed on the connector mainbody 1, the elastic arm 26 springs back to its original position, driving the connecting protrusion 29 into the window 65 of the connector body 53, thereby achieving the clamping connection between the elastic tailseat 2 and the connector mainbody 1. The connecting protrusion 29 is disposed in the window 65.

FIG. 7 is a perspective view of the ferrule-type optical fiber connector after mating.

### Connector Decoupling

The release button 59 of the connector mainbody 1 is embedded in the window 65 and abuts against the connecting protrusion 29. The release button 59 enables convenient and quick disassembly between the elastic tailseat 2 and the connector mainbody 1.

When removing the elastic tailseat 2 from the connector mainbody 1, simply press the release button 59. The release button 59 exerts a pressing force on the connecting protrusion 29, causing the connecting protrusion 29 to disengage from the window 65, and at this point, the elastic tailseat 2 automatically pops out of the connector mainbody 1.

### Advantages of the Design of Embodiment 1

### 1. Effectively Shortening the Length of the Connector

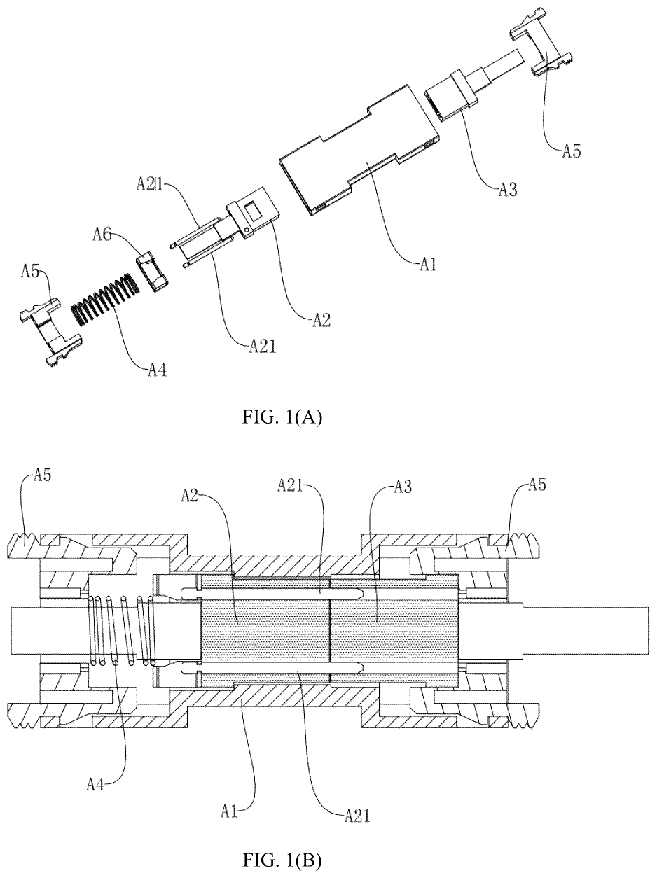

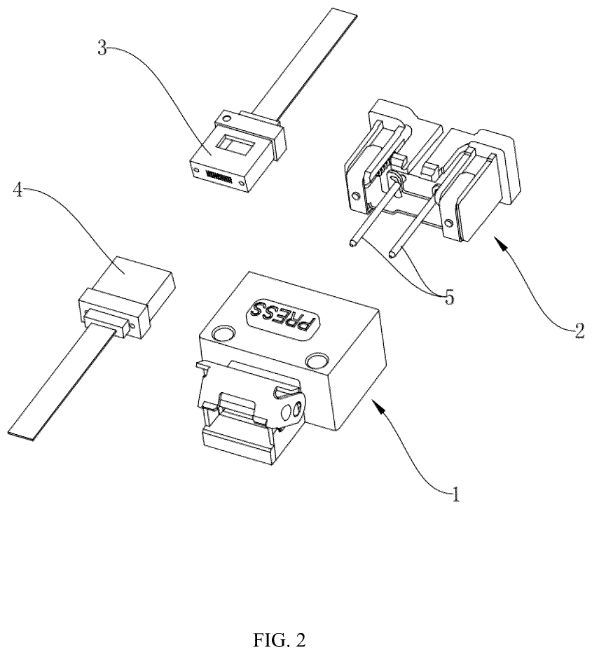

The ferrule contact surface 38 is arranged behind the flank contact surface 35 so that the positions of the first ferrule 3 and the two springs 14 partially overlap in the direction of the optical fiber harness, achieving an effective shortening of the overall length of the ferrule-type optical fiber connector. In other words, the connection between the spring 14 and the ferrule 3 is not a “series” connection as in the prior art (FIG. 1), but a “parallel”connection.

### 2. Spring Pre-Relaxation, Minimizing Guide Pin Hole Wear

When the elastic tailseat 2 is not inserted into the connector mainbody 1, the length of the spring 14 is close to its natural length. In this position, the elastic force of the spring 14 is nearly zero.

After the elastic tailseat 2 is inserted into the connector mainbody 1, the spring 14 is compressed, and the spring 14 exerts an appropriate elastic force on the ferrules, realizing the suspension of the first ferrule 3 when it is aligned and mated with the second ferrule 4, as well as the retaining force between the ferrules.

When the elastic tailseat 2 starts to be inserted into the connector mainbody 1, the guide pins on the first ferrule 3 enter the guide pin holes of the second ferrule 4. Since the spring 14 is in a relaxed state, the lateral force between the first ferrule 3 and the second ferrule 4 is extremely small, so that the guide pin holes of the second ferrule 4 will not be worn quickly. This ferrule-type optical fiber connector has a very long plugging service life.

### 3. Minimal Components and Convenient Use

This ferrule-type optical fiber connector consists of only two components, making it easy to assemble during use. The number of operating steps for this ferrule-type optical fiber connector is minimized, totaling only three essential steps.

The second ferrule 4 requires no accessories; it is directly inserted into the connector mainbody 1 and effectively fixed by the rotating swinging latch 56, featuring a compact design.

The release button 59 is an effective design that occupies minimal volume.

### Embodiment 2

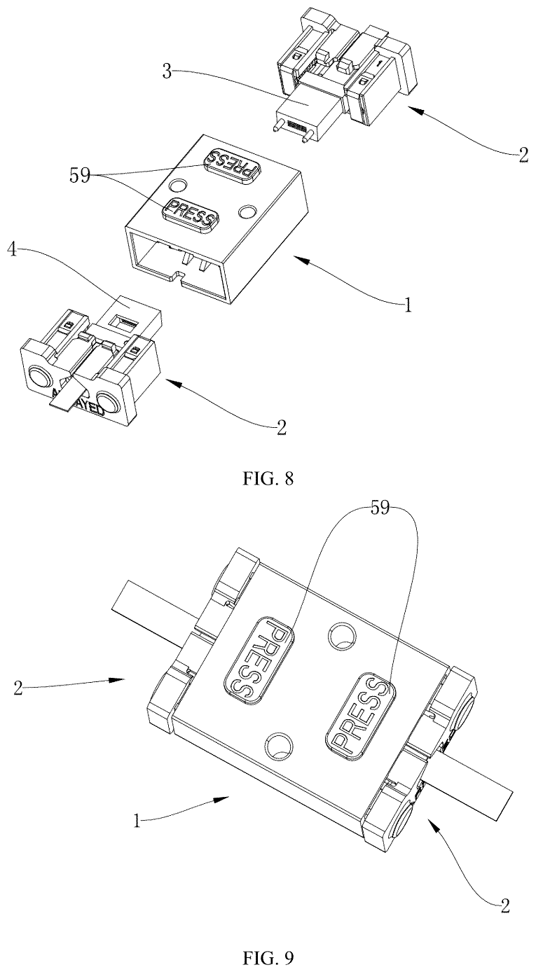

As another option, the aforementioned connector mainbody 1 can be butted with not one, but two elastic tailseat 2 from the front and rear. The second ferrule 4 is connected with the connector mainbody 1 through the elastic tailseat 2, as shown in FIG. 8.

FIG. 9 is a perspective view of embodiment 2.

This specific embodiment is merely an explanation of the present application, not a limitation thereof. After reading this specification, those skilled in the art may make modifications to this embodiment that do not involve creative contributions as needed; however, all such modifications shall be protected by the Patent Law as long as they fall within the scope of the claims of the present application.

1. A ferrule-type optical fiber connector, comprising a connector mainbody, an elastic tailseat matched with the connector mainbody, a first ferrule and a second ferrule coupled with each other, the second ferrule is set on the connector mainbody, the first ferrule is set on the elastic tailseat, the elastic tailseat comprises spring, wherein the spring is set on the side of the first ferrule;
wherein the elastic tailseat comprises a tailseat mainbody and an extending arm bracket; the first ferrule is supported on the extending arm bracket; the spring is set between the tailseat mainbody and the extending arm bracket; and
wherein the extending arm bracket is provided with a ferrule contact surface for supporting the first ferrule and two flank contact surfaces for supporting and connecting with the spring, the ferrule contact surface is arranged behind the flank contact surface, and a spring is arranged between each flank contact surface and the tailseat mainbody.

2. (canceled)

3. The ferrule-type optical fiber connector according to claim 1, wherein there are two said springs.

4. The ferrule-type optical fiber connector according to claim 1, wherein the ferrule contact surface is provided with locating guide pin; the first ferrule is installed on the extending arm bracket by inserting the locating guide pin into a guide pin hole of the first ferrule.

5. The ferrule-type optical fiber connector according to claim 4, wherein the locating guide pin extends out of the front surface of the first ferrule when the first ferrule is a male ferrule.

6. The ferrule-type optical fiber connector according to claim 1, wherein the spring is sleeved with a spring guide rod.

7. The ferrule-type optical fiber connector according to claim 1, wherein the tailseat mainbody is provided with a through groove which is capable of delivering an optical fiber harness into the tailseat mainbody.

8. The ferrule-type optical fiber connector according to claim 1, wherein the elastic tailseat and the connector mainbody are detachably clamped.

9. The ferrule-type optical fiber connector according to any claim 1, wherein the second ferrule is connected with the connector mainbody through the elastic tailseat.

10. The ferrule-type optical fiber connector according to claim 1, wherein the connector mainbody is provided with an anti-disengagement mechanism for stably mounting the second ferrule on the connector mainbody.

11. The ferrule-type optical fiber connector according to claim 10, wherein the anti-disengagement mechanism comprises a swinging latch pivotally connected to the connector mainbody, the swinging latch comprises an anti-disengagement baffle, and the anti-disengagement baffle can limit the second ferrule when the second ferrule is set on the connector mainbody.

12. The ferrule-type optical fiber connector according to claim 11, wherein an anti-disengagement locking mechanism is arranged between the swinging latch and the connector mainbody.
